(19) United States
(12) Patent Application Publication
(10) Pub. No.: US 2008/0267027 A1
(43) Pub. Date: Oct. 30, 2008

(54) Method and Apparatus for Optimizing Optical Disc Writing Strategy

(75) Inventors: Jianyi Zhong, Shanghai (CN); Jing Tao, Shanghai (CN); Gongming Wei, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,058

(22) PCT Filed: Dec. 8, 2006
(86) PCT No.: PCT/IB06/54674

§ 371 Date: Jun. 12, 2008

(30) Foreign Application Priority Data
Dec. 12, 2005 (CN) 200510022870.X

(51) Int. Cl. G11B 7/00

(52) U.S. Cl. 369/47.53

(57) ABSTRACT

The present invention provides a method and apparatus for optimizing optical disc writing strategy. The method for optimizing optical disc writing strategy comprises the steps of obtaining the information concerning whether said area to be written has experienced any writing before; searching for an area that has the corresponding information in the writing optimization area on said optical disc; and performing writing test on said area that has the corresponding information to optimize and determine an optical disc writing strategy for writing said optical disc. The method and apparatus could not only reduce the difference between the optical disc writing strategy and the real optical disc writing condition as much as possible, but also lower the requirement on the optical disc writing equipment and the cost, and could be easily realized.

### FIELD OF THE INVENTION

This invention relates to the field of optical storage, in particular to the method and apparatus for optimizing optical disc writing strategy.

### BACKGROUND OF THE INVENTION

In the field of optical storage, there are re-writable discs with a variety of formats, such as CD-RW optical disc, DVD±RW optical disc, BD-RE optical disc, etc. They are very much liked by the users because they can be written for more than a thousand times. The writing quality of re-writable optical disc is affected by many factors, such as the quality of the optical disc, the quality of the writing equipment, the writing strategy, and the number of times of direct overwrite (DOW), etc.

Each time before writing the optical disc, an appropriate writing strategy usually needs to be determined through the writing Optimum Power Control (OPC). The writing Optimum Power Control can better adapt the optical disc writing strategy to the writing properties of the optical disc and the writing equipment, and to the coordinating characteristics of the optical disc and the optical disc writing equipment, etc.

OPC is usually performed in the lead-in area of the optical disc. It can start either from the starting address of the lead-in area or from an randomly determined address of the lead-in area, so some areas of the lead-in area may experience all the times of the writing tests, while some areas of the lead-in area may only experience part of the writing tests or never experience any writing test. If the writing condition of the area to be written on the optical disc is greatly different from the writing condition of the writing test area, then there will be a great deviation between the writing strategy obtained by optimizing and the real writing condition, thus the optical disc writing effect will be affected.

A solution of optimizing optical disc writing strategy in the prior art is carried out on the basis of detailed record of the writing history information. First, the writing history information of all the areas (including the lead-in area) on the optical disc is recorded in detail; then, according to the writing history information of the area to be written, writing optimization is performed in the area of the lead-in area that has the same writing history information so as to determine an optimized optical disc writing strategy. This solution needs to record the writing of the optical disc in detail each time, and puts a very high requirement on the optical disc writing equipment, so the cost is relatively higher. In some cases, areas having the same writing condition cannot always be found for performing the writing tests, so in these cases, this solution is not practical.

Therefore, there is the need to provide a method and apparatus for optimizing the optical disc writing strategy, which could not only reduce the difference between the optical disc writing strategy and the real optical disc writing condition as much as possible, but also lower the requirement on the optical disc writing equipment and the cost, and could be easily realized.

### OBJECT AND SUMMARY OF THE INVENTION

The object of the present invention is to provide a method and apparatus for optimizing optical disc writing strategy so as to overcome the deficiencies in the prior art.

According to one embodiment of the present invention, a method for optimizing optical disc writing strategy is provided, said writing strategy being used for writing data in an area to be written of a re-writable optical disc, said method comprising the steps of obtaining the information concerning whether said area to be written has experienced any writing before; searching for an area that has the corresponding information in the writing optimization area on said optical disc; performing writing test on said area that has the corresponding information to optimize and determine an optical disc writing strategy for writing said optical disc.

According to one embodiment of the present invention, an apparatus for optimizing the writing strategy is provided, said writing strategy being used for writing data in an area to be written of a re-writable optical disc, said apparatus comprising: an obtaining means for obtaining the information concerning whether said area to be written has experienced any writing before; a searching means for searching for an area that has the corresponding information in the writing optimization area on said optical disc; and an optimizing means for performing writing test on said area that has the corresponding information so as to optimize and determine an optical disc writing strategy for writing said optical disc.

Said information concerning whether any writing has been experienced includes the information that said area to be written has never experienced any writing, or the information that it has experienced writing. Said information concerning whether any writing has been experienced could be the information record of whether said optical disc has been written on said optical disc, and it could be also determined through the following steps: detecting the optical disc reading signal of said area to be written; and determining, according to said signal, whether said area to be written has experienced any writing.

Said corresponding information includes information of whether writing has been experienced that corresponds to said area to be written, that is, the information of not having experienced writing or information of having experienced writing.

The method and apparatus for optimizing the optical disc writing strategy provided by the present invention could not only reduce the difference between the optical disc writing strategy and the real optical disc writing condition as much as possible, but also lower the requirement on the optical disc writing equipment and the cost, and said method and apparatus could be easily realized.

Other objects and attainments of the invention will become apparent and be understood fully from the following description and claims taken in conjunction with the accompanying drawings.

### BRIEF DESCRIPTION OF THE DRAWINGS

The present invention will be further illustrated in detailed by means of the embodiments with reference to the figures.

FIG. 1 is the schematic drawing of the relationships between the optical disc writing power and the jitter in the first time of DOW (DOW0) writing and the 61st time of DOW (DOW 60) writing on a 4× DVD+RW optical disc under a 2.4×;

FIG. 2 is the schematic drawing of the relationships between the optical disc writing power and the jitter in the n+1th time of DOW (DOWn, n=1, 5, 30 and 60) writing on a 4×DVD+RW optical disc under a 2.4×;

FIG. 3 is a flow chart of the method for optimizing the optical disc writing strategy according to one embodiment of the present invention;

FIG. 4 is the block diagram of the apparatus for optimizing the optical disc writing strategy according to one embodiment of the present invention.

Throughout the drawings, the same reference numerals indicate the same, similar or corresponding features or functions.

### DETAILED DESCRIPTION OF THE INVENTION

The inventive concept of the present invention is as follows: the optical disc writing condition of the first time of DOW (DOW0) writing on an area of a re-writable optical disc is significant different from the optical disc writing condition of the n+1th time of DOW (DOWn, n is integer greater than 0) writing, while although one area that has been written may differ greatly from other area that has been written in the number of times of writing, the writing conditions of said one area that has been written and said other area are quite similar, so the optical disc writing strategy obtained from the DOW0 writing test is applicable to DOW0 writing, and the optical disc writing strategy obtained from the DOWi (i is integer greater than 0) optical disc writing test is applicable to DOWj (j is integer greater than 0) optical disc writing.

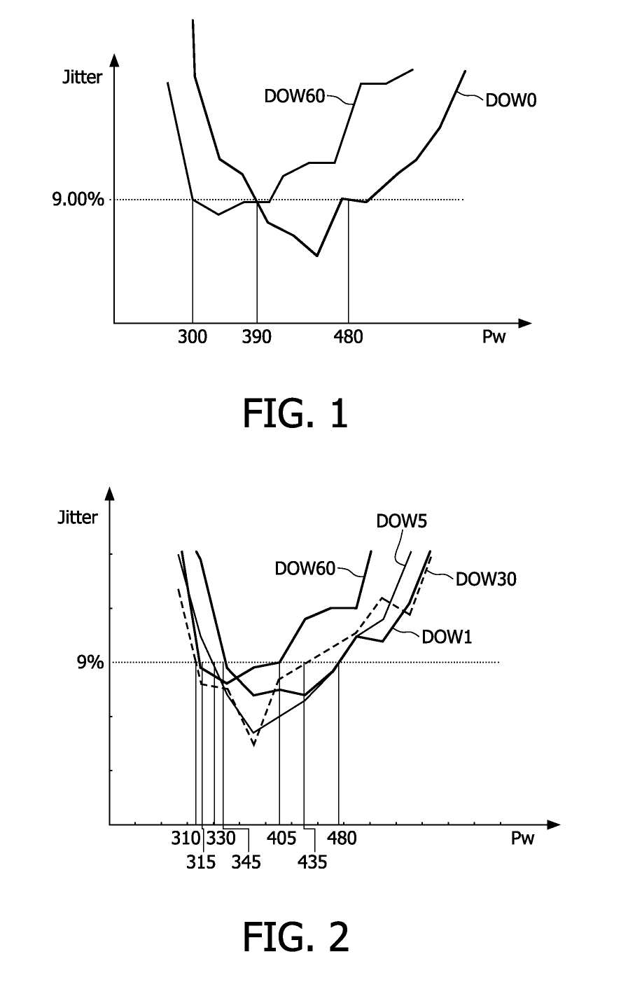

FIG. 1 is the schematic drawing of the relationships between the optical disc writing power and the jitter in the DOW0 writing and the DOW60 writing on a 4× DVD+RW optical disc under a 2.4×, wherein the X-axis represents the optical disc writing power Pw, the conversion relation between the value thereof and the real power is as shown in formula (1), the Y-axis represents the jitter, which indicates the writing quality of optical disc. The value of 9% on the Y-axis in FIG. 1 is the upper limit of the tolerable jitter in DVD+RW standard.

Read power value (milliwatt)=PwX(22/470) (1)

As shown in FIG. 1, when performing DOW0, the value of the writing power parameter Pw in the optical disc writing strategy can range from 390˜480. When performing DOW60, the value of the writing power parameter Pw ranges from 300˜390, otherwise, the jitter will exceed the requirement set by the optical disc standard. Therefore, the writing strategy obtained from DOW0 optical disc writing test is not applicable to the DOW60 optical disc writing, likewise, the writing strategy obtained from DOW60 writing test is not applicable to the DOW0 optical disc writing, either.

FIG. 2 is the schematic drawing of the relationships between the optical disc writing power and the jitter in the n+1th time of DOW (DOWn, n=1, 5, 30 and 60) writing on a 4×DVD+RW optical disc under a 2.4×. As shown in FIG. 2, the DOWn optical disc writing has different writing power value ranges due to the different values of n, for example, the value ranges of the writing power of DOW1, DOW5, DOW 30 and DOW60 are 345˜480, 330˜480, 310˜435 and 315˜405, respectively.

There is a large overlapping area in the value ranges of DOWn, such as area 345˜405 in FIG. 2. All the DOWn optical disc writing that includes said overlapping area can obtain an appropriate optical disc writing power value from said area, and the writing quality can meet the requirement of the standard.

Therefore, the optimized writing power obtained according to the DOWi (i>0) optical disc writing test can be applied to DOWj (j>0) writing, and it could meet the requirement on the optical disc writing quality.

In summary, there is a great difference between the writing condition of the optical disc area that has been written and the writing condition of the optical disc area that has not been written, but there is relatively smaller difference between the writing condition of the optical disc area that has been written and the writing condition of other areas that have experienced the writing. The optimized optical disc writing strategy obtained according to DOW0 optical disc writing test is applicable to DOW0 writing, while optimized optical disc writing strategy obtained according to DOWi (i>0) optical disc writing test is applicable to DOWj (j>0) writing.

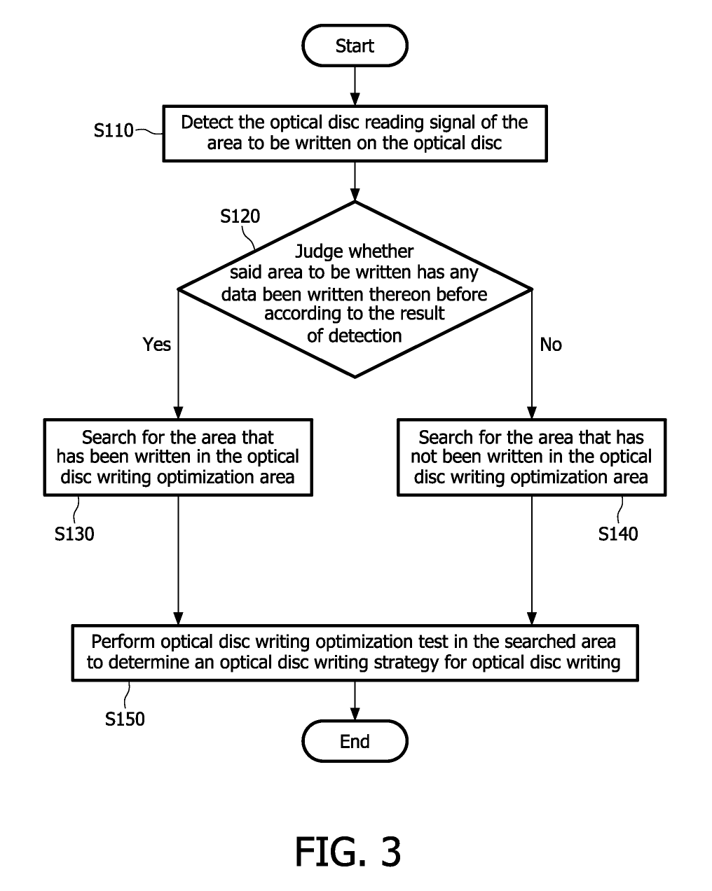

FIG. 3 is a flow chart of the method for optimizing the optical disc writing strategy according to one embodiment of the present invention. This embodiment takes DVD+RW optical disc as an example. First, the optical disc reading signal of the area to be written on the optical disc is detected (step S110). The writing conditions of the optical disc area that has been written before and the optical disc area that has never been written differ greatly, so by detecting the optical disc signal read from the area to be written, the writing condition of the area to be written can be detected.

It is judged whether said area to be written has any data been written thereon before according to the result of detection (step S120). By detecting the signal read from the optical disc, the modulation of the optical disc signal of said area to be written can be obtained.

According to DVD+RW optical disc standard, the modulation of the read signal of the optical disc storage area that has never been written is zero, while the modulation of the read signal of the optical disc area that has data written thereon is greater than 0.60. If a threshold value (such as 0.1, etc.) is set, by comparing the modulation of the optical disc read signal to said threshold value, it can be judged whether said area has been written before. If the modulation of said area to be written is greater than the set threshold value, said area has been written; otherwise, said area has not been written.

Except for obtaining information concerning whether the area to be written has experienced writing through the above-mentioned steps S110 and S120, other detection methods can also be used for the judgement. For example, if the optical disc has writing record information, the corresponding record information can be used for judgement.

If said area to be written has ever been written, the area that has experienced optical disc writing test is searched in the writing test optimization area of the optical disc (step S130). Since the difference between the writing condition of the area to be written on optical disc that has been written before and the writing condition of the optical disc writing test area that has experienced writing is relatively small, by performing writing test in the area that has experienced optical disc writing, the optimized optical disc writing strategy can meet the requirement on writing quality.

If said area to be written on said optical disc has never been written, the area that has never experienced optical disc writing test is searched in the optical disc writing optimization area (step S140). Since the difference between the writing condition of the optical disc area that has never been written and the writing condition of the optical disc writing test area that has never experienced writing is relatively small, by performing writing test in the area that has never experienced optical disc writing, the optimized optical disc writing strategy can meet the requirement on writing quality.

Since the optical disc writing strategy optimization is usually performed in the lead-in area of the optical disc, the search for the optical disc writing test area that has experienced optical disc writing is also usually performed in the lead-in area of the optical disc. If the optical disc writing equipment permits, or the optical disc does not have the area that has the corresponding information, area having the corresponding information can also be searched for in other areas of the optical disc for performing the writing strategy optimization.

Optical disc writing strategy optimization test is performed in the searched writing test area having the corresponding information, so as to determine an optical disc writing strategy for optical disc writing (step S150). The optimization of the writing parameters in the writing strategy can be performed according to methods of the prior art.

In the re-writable blu-ray optical disc criterion, OPC writing test is usually performed in the lead-in area according to the sequence of address. The optical disc writing equipment selects a section of the writing test area of the optical disc to perform writing test, and identifies the area that is written and the area that is not written by corresponding marks. The writing test area of an optical disc can be divided into a plurality of sub-areas, and a DOW0 writing test can be performed once on each of sub-areas. The number of sub-areas usually can meet the requirement imposed by the data writing area on the number of times of the DOW0 optical disc writing test.

The method for optimizing the optical disc writing strategy provided by the present invention could not only reduce the difference between the optical disc writing strategy and the real optical disc writing condition as much as possible, but also lower the requirement on the optical disc writing equipment and the cost, and could be easily realized.

The present invention also provides an optical disc writing method, which includes the method for optimizing optical disc writing strategy as shown in FIG. 3 and a step using said optimized optical disc writing strategy to perform optical disc writing.

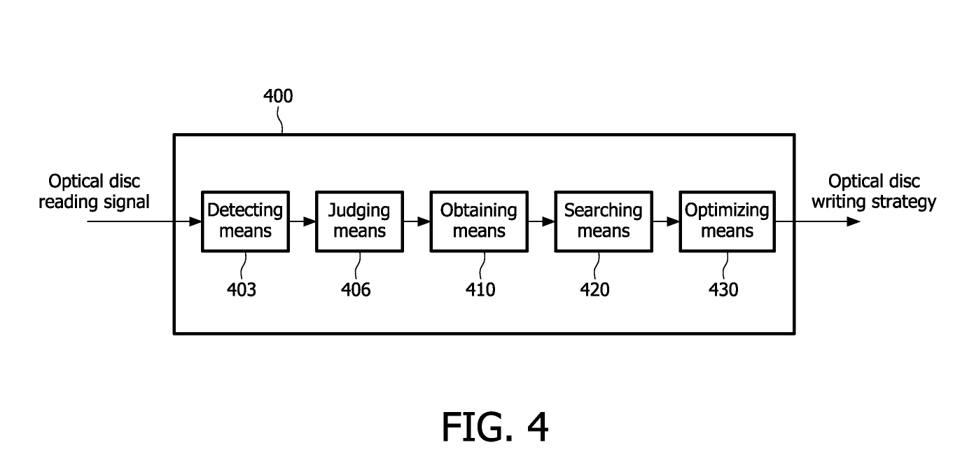

FIG. 4 is the block diagram of the apparatus 400 for optimizing the optical disc writing strategy according to one embodiment of the present invention. The apparatus 400 for optimizing the optical disc writing strategy comprises an obtaining means 410 for obtaining the information concerning whether an area to be written on said optical disc has experienced any writing before. Said information concerning whether an area to be written on said optical disc has experienced any writing before includes the information that said area to be written has never experienced any writing or the information that it has experienced writing. Said information concerning whether an area to be written on said optical disc has experienced any writing before could be the information record of whether said optical disc has been written on the said optical disc.

The apparatus 400 further comprises a searching means 420 for searching for an area that has the corresponding information in the writing optimization area on said optical disc. Said corresponding information includes information of whether writing has been experienced that corresponds to said area to be written, that is, the information of not having experienced writing or information of having experienced writing. If the area to be written has not experienced writing, the searched area includes the area that has not experienced writing test in the optical disc writing test area. If the area to be written has experienced writing, the searched area includes the area that has experienced writing test in the optical disc writing test area.

The apparatus 400 further comprises an optimizing means 430 for performing optical disc writing optimization on said area that has the corresponding information so as to determine an optical disc writing strategy for writing said optical disc. The optical disc writing strategy can be optimized according to the prior art optical disc writing test method.

The apparatus 400 can further comprise a detecting means 403 for detecting the optical disc reading signal of said area to be written, and a comparing and judging means 406 for comparing the detection result of said detecting means to a preset value, and for judging whether said area to be written has been written before.

According to detection of the optical disc reading signal, the modulation of said area to be written can be obtained. By comparing said modulation to a pre-set value, it can be judged whether said area has been written before.

The present invention also provides an optical disc writing equipment which comprises apparatus 400 for optimizing optical disc writing strategy as shown in FIG. 4, and an optical disc reading and writing means for reading signal from said optical disc and writing data on said optical disc. Said optical disc writing equipment can reduce the difference between the optical disc writing strategy and the real optical disc writing condition as much as possible, and lower the requirement on the optical disc writing equipment and the cost, and could be easily realized.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method for optimizing optical disc writing strategy, said writing strategy being used for writing data in an area to be written of a re-writable optical disc, said method comprising the steps of
obtaining the information concerning whether said area to be written has experienced any writing before;
searching for an area that has the corresponding information in a writing test area on said optical disc;
performing writing test on said area that has the corresponding information to determine an optical disc writing strategy for writing said optical disc.

2. The method according to claim 1, wherein said information concerning whether said area to be written has experienced any writing before includes the information that said area to be written has never experienced any writing.

3. The method according to claim 1, wherein said information concerning whether said area to be written has experienced any writing before includes the information that said area to be written has experienced writing.

4. The method according to claim 1, wherein said information concerning said area to be written has experienced any writing before is obtained by the following steps:
detecting the optical disc reading signal read from said area to be written; and
determining, according to said signal, whether said area to be written has experienced any writing.

5. The method according to claim 1, wherein said area having the corresponding information includes: if said area to be written has experienced writing, said area having the corresponding information is an area that has experienced writing test; if said area to be written has not experienced writing, said area having the corresponding information is an area that has not experienced writing test.

6. An optical disc writing method for writing a re-writable optical disc, said method including the steps of
obtaining the information concerning whether an area to be written of said optical disc has experienced any writing before;
searching for an area that has the corresponding information in a writing test area on said optical disc;
performing writing test on said area that has the corresponding information to determine an optical disc writing strategy; and
writing said optical disc according to said optical disc writing strategy.

7. The method according to claim 6, wherein said information concerning whether an area to be written of said optical disc has experienced any writing before includes the information that said area to be written has never experienced any writing.

8. The method according to claim 6, wherein said information concerning whether an area to be written of said optical disc has experienced any writing before includes the information that said area to be written has experienced writing.

9. The method according to claim 6, wherein said area having the corresponding information includes: if said area to be written has experienced writing, said area having the corresponding information is an area that has experienced writing test; if said area to be written has not experienced writing, said area having the corresponding information is an area that has not experienced writing test.

10. An apparatus for optimizing the writing strategy, said writing strategy being used for writing data in an area to be written of a re-writable optical disc, said apparatus comprising:
an obtaining means for obtaining the information concerning whether said area to be written has experienced any writing before;
a searching means for searching for an area that has the corresponding information in the writing test area on said optical disc; and
an optimizing means for performing writing test on said area that has the corresponding information so as to determine an optical disc writing strategy for writing said optical disc.

11. The apparatus for optimizing the writing strategy according to claim 10, wherein said information concerning whether said area to be written has experienced any writing before includes the information that said area to be written has never experienced any writing.

12. The apparatus for optimizing the writing strategy according to claim 10, wherein said information concerning whether said area to be written has experienced any writing before includes the information that said area to be written has experienced writing.

13. The apparatus for optimizing the writing strategy according to claim 10, wherein said area having the corresponding information includes: if said area to be written has experienced writing, said area having the corresponding information is an area that has experienced writing test; if said area to be written has not experienced writing, said area having the corresponding information is an area that has not experienced writing test.

14. An optical disc writing equipment for writing a re-writable optical disc, said equipment comprising:
an obtaining means for obtaining the information concerning whether an area to be written of said optical disc has experienced any writing before;
a searching means for searching for an area that has the corresponding information in the writing test area on said optical disc; and
an optimizing means for performing writing test on said area that has the corresponding information so as to determine an optical disc writing strategy; and
a writing means for writing data on said optical disc according to said optical disc writing strategy.

15. The writing equipment according to claim 14, wherein said information concerning whether an area to be written of said optical disc has experienced any writing before includes the information that said area to be written has never experienced any writing.

16. The writing equipment according to claim 14, wherein said information concerning whether an area to be written of said optical disc has experienced any writing before includes the information that said area to be written has experienced writing.

17. The writing equipment according to claim 14, wherein said area having the corresponding information includes: if said area to be written has experienced writing, said area having the corresponding information is an area that has experienced writing test; if said area to be written has not experienced writing, said area having the corresponding information is an area that has not experienced writing test.
